(19) United States
(12) Patent Application Publication
(10) Pub. No.: US 2017/0282445 A1
(43) Pub. Date: Oct. 5, 2017

(54) METHOD FOR INCREASING THE ADHESION BETWEEN THE FIRST SURFACE OF A FIRST WEB-SHAPED MATERIAL AND A FIRST SURFACE OF A SECOND WEB-SHAPED MATERIAL

(71) Applicant: TESA SE, Norderstedt (DE)

(72) Inventors: Arne KOOPS, Neu-Lankau (DE); Marco KUPSKY, Quickborn (DE); Klaus KEITE-TELGENBÜSCHER, Hamburg (DE); Stephan ZÖLLNER, Buchholz /Nordheide (DE); Thomas SCHUBERT, Hamburg (DE)

(73) Assignee: TESA SE, Norderstedt (DE)

(21) Appl. No.: 15/508,639

(22) PCT Filed: Sep. 7, 2015
(86) PCT No.: PCT/EP2015/070353

§ 371 Date: Mar. 3, 2017

(30) Foreign Application Priority Data
Sep. 5, 2014 (DE) 10 2014 217 821.5

(51) Int. Cl. B29C 65/00; C09J 7/02; C09J 5/02

(52) U.S. Cl. CPC B29C 66/028; C09J 5/02; C09J 7/0207; B29C 66/723; B29C 66/81263; C09J 2205/31; C09J 2201/606; C09J 2201/128

(57) ABSTRACT

A method for increasing the adhesion between the first surface of a first web-shaped material and a first surface of a second web-shaped material, the first web-shaped material and the second web-shaped material being fed continuously and with the same web direction to a laminating gap, in which the first web-shaped material and the second web-shaped material are laminated together by means of the first surfaces thereof, the two first surfaces being treated with a single plasma simultaneously and preferably over the entire area, the laminating gap being formed by a pressing element and a counter-pressure device, which builds up a counter pressure, and preferably at least one of the lateral surfaces of the pressing element and of the counter-pressure device or both being equipped with a dielectric, characterized in that none of the two first surfaces/web-shaped materials are guided through the discharge zone of the plasma-generating device.

This application is a 371 of PCT/EP2015/070353, filed Sep. 7, 2015, which claims foreign priority benefit under 35 U.S.C. §119 of the German Patent Application No. 10 2014 217 821.5, filed Sep. 5, 2014, the disclosures of which patent applications are incorporated herein by reference.

The invention pertains to a method for increasing the adhesion between the first surface of a first web-type material and a first surface of a second web-type material.

In the sector of industrial manufacture, the demand exists for simple pretreatment techniques in order to improve the adhesive bonding properties of an adherend.
Costly and inconvenient operations such as wet-chemical cleaning and priming of the adherend surface are typically used in order to obtain high-strength bonds with a self-adhesive tape.
In particular, the simple physical pretreatment techniques under atmospheric pressure (corona, plasma, flame) are nowadays used with advantage for the surface treatment of the adherend for the purpose of achieving a higher anchoring force with a self-adhesive tape.

To improve the adhesion properties of adherend surfaces and pressure-sensitive adhesive tape, it is possible to carry out pretreatments of the surfaces. These pretreatments mediate and/or strengthen the intermolecular forces of the bond partners. There are various possibilities of pretreatment, including chemical pretreatment by primer application or physical pretreatment by plasma or corona treatment.

An introduction to surface treatment is provided by the book “Kleben-Grundlagen, Technologien, Anwendungen” by G. Habenicht, 2009, Springer Verlag, Berlin/Heidelberg.

The strength of adhesive bonds, or the bond of surface to pressure-sensitive adhesive tape, can be strengthened by means of chemical bridges. The basis for these chemical bridges is provided by organosilicon compounds (silanes). As well as increased strength, they also permit improved aging relative to moist atmospheres. The chemical primer for this purpose is applied prior to the application of the pressure-sensitive adhesive tape on the surface. It is important here that the primer layer is extremely thin, in some cases monomolecular, since the intermolecular forces between the silane molecules are weak. The bifunctional adhesion promoter reacts subsequently with the adherend surface (polycondensation reaction) and with the adhesive molecules of the pressure-sensitive adhesive tape (polyaddition or addition-polymerization reaction).

The reaction mechanism is represented schematically in the appended drawing (FIG. 12).

Plasma is the term for the 4^{th} aggregate state of matter. It comprises a partly or completely ionized gas. By supply of energy, positive and negative ions, electrons, other excited states, radicals, electromagnetic radiation, and chemical reaction products are generated. Many of these species can lead to changes to the surface to be treated. All in all, this treatment leads to activation of the adherend surface—specifically, to greater reactivity.

This treatment may be carried out both on the surface of the adherend and on the adhesive. A combination of both treatments is likewise possible. This treatment is also used to increase the adhesion between the first surface of a first web-type material (an adhesive, for example) and a first surface of a second web-type material (a carrier material, for example).

Widely used corona treatment, also called corona discharge or dielectric barrier discharge, represents a filamentary plasma and predominantly takes the form of a high-voltage discharge with direct contact to the surface to be treated. The discharge converts gas in the ambient air into a reactive form. The collision of the impinging electrons on the adherend surface causes molecules to split. The resulting free valences permit accretion of the reaction products of the corona discharge. These accretions permit improved adhesion properties on the part of the adherend surface, but can also cause damage to the surface by way of the direct effect of the discharge.

Where two or more than two layers are to be laminated to one another, one or both interfaces are typically pretreated physically prior to the lamination.

It is known that treatment by plasma has a limited durability in terms of the activation of the boundary layer, and so treatment takes place at a time near to or, primarily, directly before the laminating operation.

Plasma and more particularly corona pretreatments are described or referred to for example in DE 10 2005 027 391 A1 and DE 103 47 025 A1.

DE 10 2007 063 021 A1 describes activation of adhesives by corona treatment. It is disclosed that the prior corona pretreatment of the adhesive is beneficial to the holding power and the flow-on behavior of the adhesive bond. Only the adhesive is treated, not the substrate. It was not recognized that the process can produce an increase in the peel adhesion.

Like DE 10 2007 063 021 A1, DE 10 2011 075 470 A1 describes the physical pretreatment of adhesive and carrier/substrate. The pretreatments are carried out separately before the joining step and are designed differently. The double-sided pretreatment produces higher peel adhesion and anchoring forces than in the case of only substrate-side pretreatment.

In the case of DE 24 60 432 A, two webs are to be joined to a laminate by introduction of a plastic polymeric film which serves as an adhesion promoter. The plasma forms between the two laminating rolls, which are grounded, and a high-voltage electrode, which at the same time has a passage for the adhesion promoter. The air flowing around the roll is said to be influenced in form by the plasma so that the adhesion promoter does not cool too early and there are no inclusions of air in the laminate. The surfaces to be treated are fed directly through the discharge zone.

DE 27 54 425 A makes reference to DE 24 60 432 A. New arrangements are described for the same problem addressed. In this case, according to FIG. 1, the plasma is formed between the two laminating rolls, of which one has a dielectric covering. As in DE 24 60 432 A, only the lamination of flat-film webs by means of a thermoplastic polymer melt is described. Here too, the surfaces to be treated are fed directly through the discharge zone.

DE 198 46 814 A1 describes various arrangements which, in accordance with the stated objective, ensure improved corona treatment of the webs prior to lamination. Webs are referred to only generally, and the term “films” is stated only in connection with DE 198 02 662 A1. There is no naming of adhesives.

Here, again, the plasma according to claim 2 is formed between two laminating rolls. The dielectric is formed by at least one co-traveling belt. Here too, the surfaces to be treated are fed directly through the discharge zone.

DE 41 27 723 A1 describes the production of multilayer laminates of polymeric film webs and plastics plates, in which at least one joining side is treated with an aerosol corona directly ahead of the joining step. According to FIG. 1, two corona discharges are generated by the electrodes 11 and 11′ against the rolls 3 and 4, respectively. By means of a nozzle, the gas space in the roll nip is filled with an aerosol. The aerosol introduced enters the corona discharges as well, as a result of the pressurized flow. Aerosols contemplated include monomers, dispersions, colloidal systems, emulsions or solutions. Both surfaces to be treated are each fed directly through the discharge zone.

A feature of the prior art is that the pretreatments relate predominantly to the carrier material or the adherend, in order to develop greater anchoring force to the adhesive or to the self-adhesive tape. The treatment of adhesive and substrate is known. In general, the treatment is performed with separate plasma discharge devices. With simultaneous treatment of adhesive and substrate, according to the prior art both are fed directly through the discharge zone, which entails the risk of surface damage and thus reduced adhesion forces.

Although such plasma/corona treatments can be used to provide a clear boost to the anchoring forces relative to untreated band partners, a kind of limit is found in many systems which do not go into cohesive fracture, this limit being impossible to overcome with the corona and plasma systems to date.

As has been determined in the context of this invention, the reason for this lies in the nature of the adhesives and in their interaction with the substrates. Interaction here is mostly via charges or functional groups. These functional groups are generated on the surfaces by plasma or corona pretreatment and are diverse and different in their nature. Essentially they come about immediately after the end of the contact between plasma or corona and surface, as a result of reactions with atmospheric oxygen. These groups can be controlled partly, within narrow limits, by the process gases and process modes used. A significant boost, accordingly, is possible only if covalent bonds can be generated between the bond partners.

The issue which arises from this is whether it is possible, by means of an appropriate method regime, to generate these covalent bonds without the radicals reacting with gaseous components on the treated surfaces prior thereto.

It is an object of the invention to find the specified positive effects on physical surface modification of pressure-sensitive adhesives and carrier materials, in order to achieve high-strength bonds. The focal point of the invention is the achievement of high anchoring between the pressure-sensitive adhesive layer and the carrier material.

This object is achieved by means of a method as described hereinbelow.

The invention relates accordingly to a method for increasing the adhesion between the first surface of a first web-type material and a first surface of a second web-type material, wherein
the first web-type material and the second web-type material are fed continuously and with identical web direction to a laminating gap, in which the first web-type material and the second web-type material are laminated together each by their first surface,
both first surfaces of the first web-type material and of the second web-type material are treated simultaneously and preferably over the full area with a single plasma, more preferably such that the plasma, beginning ahead of the laminating gap up to the laminating gap, acts continuously on the two first surfaces,
the laminating gap is formed by a pressing element and a counter-pressure device which develops a counter-pressure,
preferably at least one of the cylindrical surfaces of the pressing element and of the counter-pressure device, or both, are furnished with a dielectric,

characterized in that

none of the two first surfaces/web-type materials is fed through the discharge zone of the plasma generating device.

### BRIEF DESCRIPTION OF THE DRAWINGS

The invention will now be described in greater detail with reference to the drawings, wherein:

FIG. 1 shows a non-inventive method—the nozzle is absent.

FIG. 2 represents a method according to the invention, showing only in each case one quarter of the rolls.

FIG. 3 shows a laminating gap which is formed by a pressing roll, which builds up the pressure desired for lamination, and by the substrate.

FIG. 4 shows an embodiment wherein a pressing element is used in the form of a pressing plate with semicylindrical laminating surface.

FIG. 5 shows a pendular nozzle, an example of which can be found in DE 20 2008 013 560 U1.

FIG. 6 shows a variety of nozzles.

FIG. 7 shows two rotary nozzles possessing different outlet angles for the concentric perforated nozzles.

FIG. 8 shows the PlasmaCurtain from Acxys.

FIG. 9 shows The SpotTEC from Tantec.

FIG. 10 depicts the use of two perforated nozzles offered by the company Tigres for larger treatment widths.

FIG. 11 depicts the use of nozzles offered by the company Tantec.

FIG. 12 depicts reacts an adhesion reaction mechanism schematically.

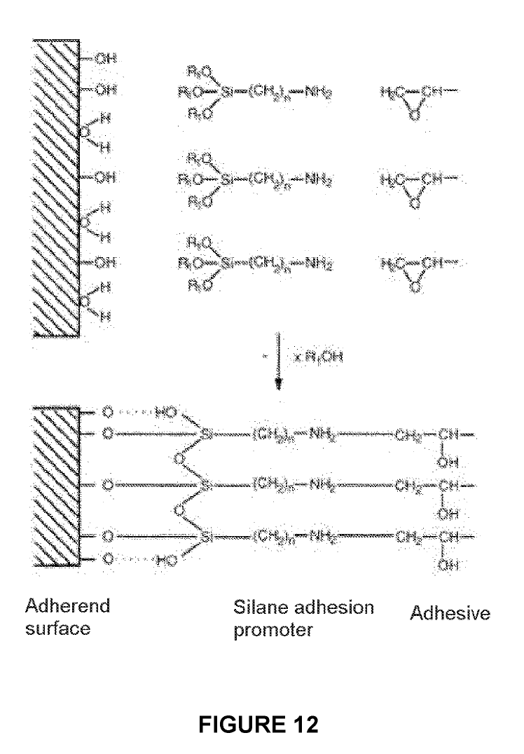

According to one preferred embodiment of the invention, the pressing element or the counter-pressure device are configured as a roll; more preferably, pressing element and counter-pressure device are configured simultaneously as a roll.

The pressing element may also be configured as a doctor blade or pressing plate.

The counter-pressure device may also be the substrate.

Avoiding contact between the first surfaces and the discharge zone of one plasma generation device allows gentle treatment in the afterglow of the plasma. In the known plasma generation devices, the plasma is blown from a gas stream from the discharge zone, meaning that these are also called plasma nozzles.

In contrast to known methods, in which the web-type materials are passed through the discharge zone of the plasma generation device, there is no risk here either of the second surfaces of the webs being plasma-treated. In the discharge zone, such reverse-face treatment occurs on the reverse face even in extremely small gas volumes, and is difficult to avoid. If the reverse face is furnished antiadhesively, for example, this furnishing would be damaged.

The activated plasma (“afterglow”) separated from the discharge zone is preferably carried, by a gas stream, for example, in the direction of the laminating gap and consequently the laminating nip opened by roll and underlayer is filled with the excited gas. Accordingly, atmospheric gas can be displaced, and unwanted reactions of the activated surfaces, particularly with atmospheric oxygen, can be reduced. The advantage of using a single plasma generation device is manifested here, since such a device is easier to accommodate, and to align correspondingly, in the narrow structural space within the nip between laminating roll and underlayer.

The treatment of the two first surfaces preferably takes place, accordingly, in such a way that the plasma, beginning ahead of the laminating gap and up to the laminating gap, in other words the line at which the two first surfaces make contact with one another, acts continuously on the two first surfaces.

Acting continuously here means that the web movement of the substrate webs through the plasma zone remains continuous. The plasma itself may also be pulsed, such as, for example, in the frequency range from about 1 Hz up to 10 MHz, which is known to the skilled person.

The first web-type material has a layer of adhesive which is arranged in the first web-type material in such a way that it forms the first surface of the first web-type material.

The principle of the preferred plasma generating devices is that a gas flow (air, gas, gas mixtures) is passed through the discharge zone and only the activated gas flow is brought to the location of treatment. The term “discharge zone” in such a plasma nozzle refers to the space in which a plasma can be ignited by adequate strength of the electric field, depending on construction.

Producers of plasma generating devices offer suitable plasma nozzle geometries which are able to treat in a laminating nip but according to the prior art are in principle employed only for a specific interface (gap, surface, three-dimensional).

Examples of suitable nozzles from the company Plasmatreat include perforated, slot, and rotary nozzles. Nozzles of this kind operate with an arc discharge or corona discharge which is operated in the interior of a nozzle. The nozzle outlet is generally grounded, meaning that this structural form operates in a potential-free manner relative to substrate. This kind of nozzle is often termed a plasma jet.

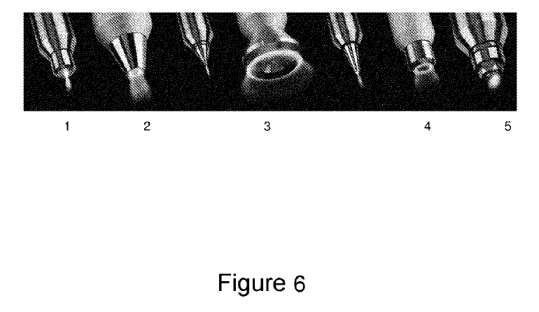

The nozzles below can be seen in FIG. 6.
1 Perforated nozzle: Pointwise plasma jet with low treatment width but intense treatment
2 Annular outlet nozzle: Stationary, circular plasma jet
3 Rotary nozzle: Rotating-pointwise plasma jet with wide treatment width;
   (see also WO 01/43512 A1)
4 Rotary nozzle: Rotating-pointwise plasma jet with smaller treatment width, depending on the outlet angle of the concentric outlet opening in the rotating nozzle
5 Slot nozzle: Outlet opening is slotlike and can possess different crosspiece widths

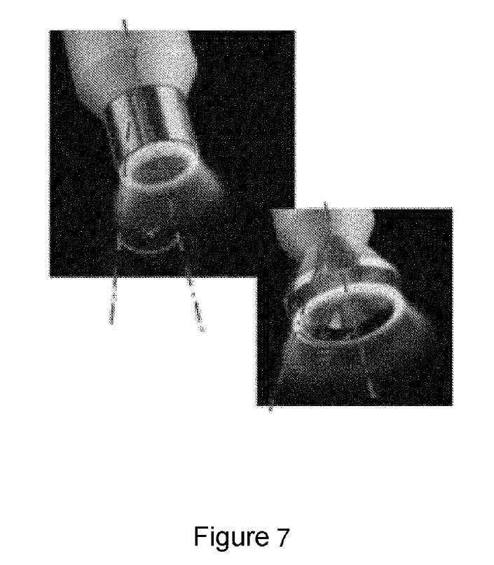

The outlet angle on a rotary nozzle exerts an influence over the treatment width. FIG. 7 shows two rotary nozzles possessing different outlet angles for the concentric perforated nozzles. Accordingly, one nozzle can be adapted for specific laminating angles (acute, flat).

Also known and suitable are pendular nozzles.

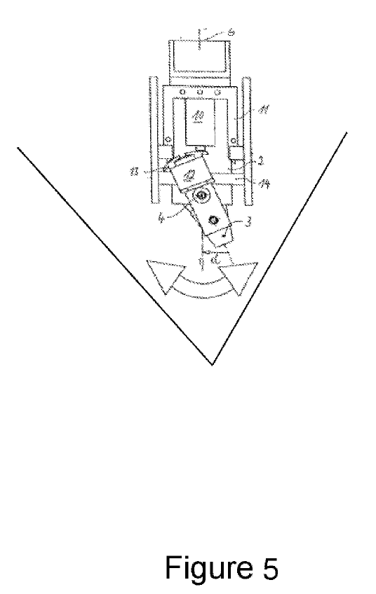

With this type of nozzle, the nozzle head is diverted by a high-frequency pendular movement. As a result, higher treatment widths or longer treatment paths before the laminating gap can be realized. One example of a pendular nozzle can be found in DE 20 2008 013 560 U1 and is shown in FIG. 5.

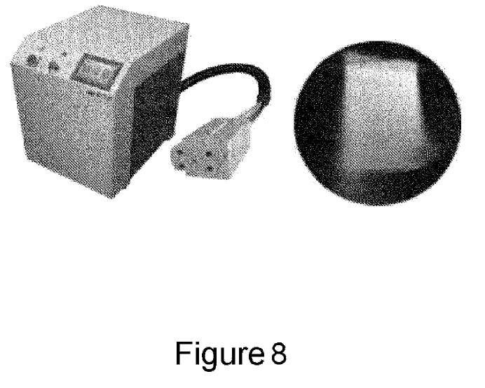

Known and suitable are further types of nozzle, an example being the PlasmaCurtain from the company Acxys (see FIG. 8).

This is a linear nozzle or a multiple arrangement of perforated nozzles (plasma jets), which is brought to the treatment surface in the form of a plasma curtain by means of flow geometries. This curtain can be delivered with either turbulent or laminar flow, for intense pretreatment of the surface and more effective displacement of the surrounding atmosphere.

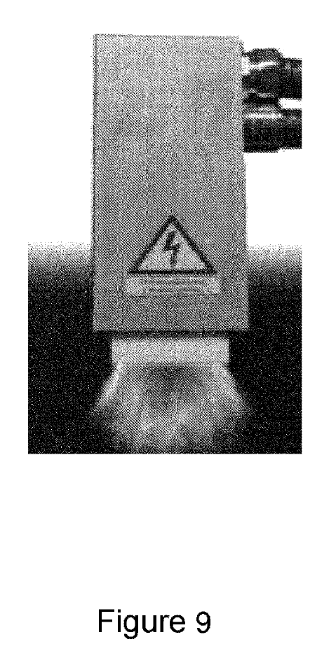

The SpotTEC from Tantec looks like this (see FIG. 9):

The principle of the unit is to bring the filamentary plasma (corona) between two stirrup electrodes in the substrate direction by blowing out using compressed air or other gases/gas mixtures. A suitable flow of the gas ensures that the pretreatment penetrates deep into the pretreatment nip. This type of plasma nozzle is referred to as “blown corona”. A potential is developed counter to the substrate so that in the case of metal substrates flashover easily occurs.

The plasma nozzles, ultimately, are predominantly suitable for a laminating nip. Treatment of a wide laminating gap is possible if the pretreatment unit is arranged with a plurality of units next to one another.

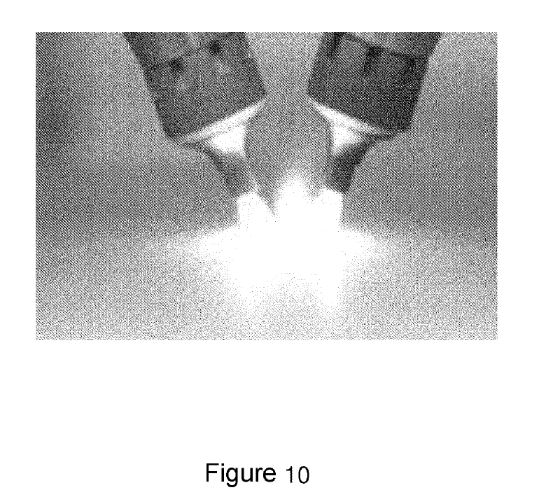

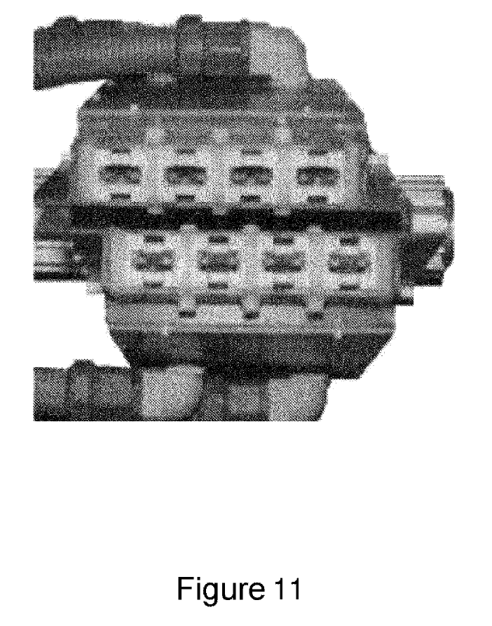

Solutions for this are offered by the company Tigres, where two perforated nozzles (plasma jets) are used for larger treatment widths (see FIG. 10), or by the company Tantec (see FIG. 11), in which case parallel corona stirrup electrodes are used.

The first surfaces are preferably treated over the full area. For certain applications, however, part-area treatment may also make sense, in the form of stripes in the web direction, for example, which are generated by plasma nozzles arranged correspondingly at a distance alongside one another. Stripes transverse to the web direction are also possible, for example, by means of plasma pulses or shutter masks.

The first and second web-type materials preferably run with identical web direction into the laminating gap.

Since the plasma is developed preferably up to the laminating gap, the first web-type material and the second web-type material are laminated together in the plasma each by their first surface.

According to a further preferred embodiment of the invention, an arbitrary point on the plasma-treated surface of the first web-type material and/or the second web-type material travels the path from the start of the plasma treatment up to the laminating gap in a timespan of less than 2.0 s, preferably less than 1.0 s, more preferably less than 0.5 s. Times of less than 0.5 s, preferably less than 0.3 s, more preferably less than 0.1 s are also possible in accordance with the invention.

According to one variant of the invention, a third web-type material is fed to the laminating gap such that the second web-type material lies between the first and third web-type materials. In this case, advantageously, a pair of webs is to be treated with a plasma nozzle in each case. It is particularly advantageous for all four surfaces for treatment to be treated with a single plasma nozzle, something which can be realized by arranging the plasma nozzle at the side of the web. In addition to this, a further plasma nozzle may be arranged on the other side of the web.

The web direction of the third web-type material is the same as that exhibited by the first and second web-type materials.

In a further variant of the invention, the laminating gap is supplied not only with the first and second web-type materials but also with a multiplicity of further web-type materials, the feed taking place in such a way that the individual web-type materials enter the laminating gap between the first and second web-type materials. The individual further web-type materials are selected such that in the laminating gap a non-adhesive carrier layer and a second non-adhesive carrier layer are never laminated directly to one another.

The laminating gap is formed by a pressing element, preferably a pressure roll, and by a counter-pressure device, which develops the counter-pressure desired for lamination. It is preferably a counter-pressure roll. The rolls preferably run counter-rotatingly, more preferably at identical peripheral speed.

In the laminating gap, the peripheral speed and the direction of rotation of the rolls are identical to the web speed and web direction of the first and second web-type materials. Any further webs present, with further preference, likewise have identical web speed and web direction.

The rolls preferably have the same diameter, the diameter more preferably being between 50 to 500 mm. The cylindrical surface of the rolls is preferably smooth, and more particularly is ground.

The surface roughness of the rolls, Rₐ, is preferably less than 0 μm, preferably less than 10 μm. “Rₐ” is a unit for the industrial standard for the quality of final surface machining, and represents the average height of the roughness, more particularly the average absolute distance from the center line of the roughness profile within the region under evaluation.

At least one of the cylindrical surfaces of the pressing element or of the counter-pressure device is lined with a dielectric. The selection is made as a function of the selection and distance of the plasma nozzle. For potential-free plasma generation devices, it is also possible to select unlined cylindrical surfaces, rolls in particular; for devices which are not potential-free, cylindrical surfaces (rolls) lined with a dielectric are advantageous. Whether they are actually necessary depends on the distance of the device from the cylindrical surface (roll).

The cylindrical surface of the device or element, in particular a roll, not covered with a dielectric may consist of steel, stainless steel or chromed steel. The surface may also have been plated with nickel or with gold. The surface ought not to exhibit any corrosion under plasma exposure.

It is possible, furthermore, for one or both rolls to be heated or cooled in a preferred range from −40° C. to 200° C. using oil, water, steam, electrically, or with other thermal conditioning media. Preferably both rolls are unheated.

For the layer of the dielectric, which covers the entire cylindrical surface (also called, for simplification, surface), i.e., for example the entire periphery of the roll(s), preference is given to selecting ceramic, glass, plastics, rubber such as styrene-butadiene rubbers, chloroprene rubbers, butadiene rubbers (BR), acrylonitrile-butadiene rubbers (NBR), butyl rubbers (IIR), ethylene-propylene-diene rubbers (EPDM), and polyisoprene rubbers (IR), or silicone.

The dielectric surrounds the roll(s) firmly, but may also be detachable, in the form of two half-shells, for example.

The thickness of the layer of the dielectric on the cylindrical surface or surfaces (roll or rolls) is preferably between 1 to 5 mm.

In accordance with the invention, the dielectric is not a co-traveling web which covers the cylindrical surface only sectionally (or two co-traveling webs which cover cylindrical surfaces for example of two rolls only sectionally).

According to one preferred variant, only one roll of the roll pair forming the laminating gap is covered with a dielectric.

According to one preferred variant, both rolls of the roll pair which forms the laminating gap are covered with a dielectric.

Plasma treatment takes place under a pressure which is close to (+/−0.05 bar) or at atmospheric pressure.

Plasma treatment may take place in various atmospheres, and the atmosphere may also comprise air. The treatment atmosphere may be a mixture of different gases, selected inter alia from N₂, O₂, H₂, CO₂, Ar, He, ammonia, forming gases, gas mixtures with O₂ and H₂, and, additionally, steam or other constituents may have been admixed. This exemplary listing is not a limitation.

According to one advantageous embodiment of the invention, the following pure or mixed process gases form a treatment atmosphere: N₂, compressed air, O₂, H₂, CO₂, Ar, He, ammonia, ethylene, siloxanes, acrylic acids and/or solvents, and, additionally, steam or other volatile constituents may have been added. Preference is given to N₂ and compressed air.

The atmospheric pressure plasma may be formed from a mixture of process gases, in which case the mixture preferably contains at least 90 vol % nitrogen and at least one noble gas, preferably argon.

According to one preferred embodiment of the invention, the mixture consists of nitrogen and at least one noble gas, and with further preference the mixture consists of nitrogen and argon.

In principle it is also possible to admix coating or polymerizing constituents to the atmosphere, in the form of gas (ethylene, for example) or liquids (atomized as aerosol). There is virtually no restriction to the aerosols that are suitable. The method according to the invention for treatment in the afterglow is especially suitable for use with aerosols, since in that case there is no risk of electrode fouling.

The proportion thereof, however, ought not to exceed 5 vol %.

Commonly used gas flows are 10 to 500 l/min, in order to carry the filament or the activated plasma separated from the discharge (“afterglow”) into the laminating gap.

Types of nozzles suitable in principle for generating the plasma and for acting on the web-type materials are all types of nozzle stated, both first surfaces are treated simultaneously.

One possible variant of the plasma treatment is the use of a fixed plasma jet.

A likewise possible plasma treatment uses an arrangement of two or more nozzles, offset, if necessary, for the gap-less, partially overlapping treatment in sufficient width.

In principle it is possible to use rotating or nonrotating nozzles.

Linear nozzles are particularly suitable, and extend advantageously along the entire length of the laminating gap.

With further preference, these electrodes have a constant distance from the laminating gap over the entire length of the laminating gap.

According to another advantageous embodiment of the invention, the distance of the plasma generating device from the laminating gap is 1 to 100 mm, preferably 3 to 50 mm, more preferably 4 to 20 mm.

With further preference, the plasma generator can be shifted in its height perpendicular to the plane which is in turn perpendicular to the plane defined by the roll axes, and preferably can be displaced simultaneously in its height and in its distance from the laminating gap.

For further preference, the speed with which the webs are fed into the laminating gap is between 0.5 to 200 m/min, preferably 1 to 50 m/min, more preferably 2 to 20 m/min (in each case including the specified marginal values of the ranges).

According to one advantageous embodiment of the invention, the web speeds of the first, second, third or other web are the same.

The first web-type material has a layer of adhesive which is arranged in the first web-type material in such a way that it forms the first surface of the first web-type material.

The first web-type material may be a double-sided adhesive tape, consisting of a first layer of adhesive, a carrier material, and a second layer of adhesive, which is optionally lined additionally for protection with a so-called liner.

A liner (release paper, release film) is not part of an adhesive tape or label, but is instead only a means for its production, storage or for further processing by die cutting. Unlike an adhesive tape carrier, moreover, a liner is not firmly joined to a layer of adhesive.

The first web-type material is preferably an “adhesive transfer tape”, i.e., an adhesive tape without carrier. Single-layer, double-sided self-adhesive tapes, known as transfer tapes, are constructed such that the pressure-sensitive adhesive layer, which forms the single layer, contains no carrier and is lined only with corresponding release materials, such as siliconized release paper or release films, for example.

With particular preference the first web-type material comprises or consists of a pressure-sensitive adhesive, in other words an adhesive which permits a durable connection to virtually all the substrates under just relatively gentle applied pressure and which after use can be detached from the substrate again substantially without residue. At room temperature, a pressure-sensitive adhesive is permanently tacky, thus having a sufficiently low viscosity and a high initial tack, so that it wets the surface of the respective bond substrate under just gentle applied pressure. The bondability of the adhesive derives from its adhesive properties, and its redetachability from its cohesive properties.

The pressure-sensitive adhesive layer is based preferably on natural rubber, synthetic rubber, or polyurethanes, with the pressure-sensitive adhesive layer preferably consisting of pure acrylate or primarily of acrylate.

For the purpose of improving the adhesive properties, the pressure-sensitive adhesive may have been blended with tackifiers.

Tackifiers, also referred to as tackifying resins, that are suitable in principle are all known classes of compound. Tackifiers are, for example, hydrocarbon resins (for example, polymers based on unsaturated C₅ or C₉ monomers), terpene-phenolic resins, polyterpene resins based on raw materials such as, for example, alpha- or beta-pinene, aromatic resins such as coumarone-indene resins or resins based on styrene or alpha-methylstyrene such as rosin and its derivatives, examples being disproportionated, dimerized or esterified rosin, as for example reaction products with glycol, glycerol or pentaerythritol, to name but a few. Preference is given to resins without easily oxidizable double bonds such as terpene-phenolic resins, aromatic resins, and, more preferably, resins prepared by hydrogenation, such as hydrogenated aromatic resins, hydrogenated polycyclopentadiene resins, hydrogenated rosin derivatives or hydrogenated polyterpene resins, for example.

Preferred resins are those based on terpene-phenols and rosin esters. Likewise preferred are tackifying resins having a softening point of more than 80° C. according to ASTM E28-99 (2009). Particularly preferred resins are those based on terpene-phenols and rosin esters with a softening point of more than 90° C. according to ASTM E28-99 (2009). Typical quantities for use are 10 to 100 parts by weight based on polymers of the adhesive.

For further improvement in the cable compatibility, the adhesive formulation may optionally have been blended with light stabilizers or primary and/or secondary aging inhibitors.

To improve the processing properties, the adhesive formulation may further have been blended with customary process auxiliaries such as defoamers, deaerating agents, wetting agents or flow control agents. Suitable concentrations are situated in the range from 0.1 up to 5 parts by weight, based on the solids.

Web-type materials are limited in their extent in terms of width and height, and are undefined in terms of their length. The length is a multiple of width and height, generally at least ten times the move extensive of the two. Also included are webs of high thickness or three-dimensional geometry, such as extruded profiles, for example.

With further preference the second web-type material is a carrier material.

Preferably employed presently as carrier material are polymer films or film composites. Such films/film composites may consist of all common plastics used for film production: by way of example, but without restriction, the following may be mentioned:

Polyethylene, polypropylene—especially the oriented polypropylene (OPP) produced by monoaxial or biaxial stretching, cyclic olefin copolymers (COC), polyvinyl chloride (PVC), polyesters—especially polyethylene terephthalate (PET) and polyethylene naphthalate (PEN), ethylene-vinyl alcohol (EVOH), polyvinylidene chloride (PVDC), polyvinylidene fluoride (PVDF), polyacrylonitrile (PAN), polycarbonate (PC), polyamide (PA), polyethersulfone (PES) or polyimide (PI).

These materials are also employed preferably as carrier layer in the first web-type material if a carrier is present in that material.

Carrier material in the sense of the invention encompasses, in particular, all sheet-like structures, examples being two-dimensionally extended films or film sections, tapes with extended length and limited width.

According to another preferred variant of the invention, the second web-type material is viscoelastic.

A viscoelastic polymer layer may be regarded as a fluid of very high viscosity, which exhibits flow (also referred to as “creep”) behavior under compressive load. Such viscoelastic polymers or a polymer layer of this kind possess or possesses to a particular degree the capacity, under slow exposure to force, to relax the forces which act on it/them. They are capable of dissipating the forces into vibrations and/or deformations (which more particularly may also—at least partly—be reversible), and thus of “buffering” the acting forces, and preferably of avoiding mechanical destruction by the acting forces, but advantageously at least of reducing such mechanical destruction or else of at least delaying the time of onset of the destruction. In the case of a force which acts very quickly, viscoelastic polymers customarily exhibit an elastic behavior, in other words the behavior of a fully reversible deformation, and forces which exceed the elasticity of the polymers may cause fracture. In contrast to this are elastic materials, which exhibit the described elastic behavior even under slow exposure to force. By means of admixtures, fillers, foaming or the like, it is also possible for such viscoelastic adhesives to be varied greatly in their properties.

Owing to the elastic fractions of the viscoelastic polymer layer, which in turn make a substantial contribution to the technical adhesive properties of adhesive tapes featuring a viscoelastic carrier layer of this kind, it is not possible for the tension, for example, of a tensile or shearing stress to be relaxed completely. This fact is expressed through the relaxation capacity, which is defined as ((stress (t=0)−stress (t)/stress (t=0))*100%. Viscoelastic carrier layers typically display a relaxation capacity of more than 50%.

Expandable microballoons serve with particular preference for foaming.

Microballoons are elastic hollow spheres having a thermoplastic polymer shell. These spheres are filled with low-boiling liquids or liquefied gas. Shell material used is, in particular, polyacrylonitrile, PVDC, PVC or polyacrylates. Suitable low-boiling fluids are, in particular, hydrocarbons of the lower alkanes, such as isobutane or isopentane, for example, which are enclosed in the form of liquefied gas under pressure in the polymer shell.

The second web-type material may also be or comprise an adhesive.

With further preference the third web-type material comprises or consists of a layer of adhesive, and with further preference the adhesive is a pressure-sensitive adhesive.

Adhesives which can be used as (pressure-sensitive) adhesives are all of those identified above.

According to one particularly advantageous embodiment of the invention, a three-layer product is laminated together. To both sides of an adhesive or nonadhesive, acrylate-based foam carrier (second web-type material), pressure-sensitive adhesives (first and third web-type materials) are laminated on.

Not ruled out in accordance with the invention is the subjection of some or all of the surfaces involved in the method to a first physical pretreatment (optionally also a plasma treatment).

Lastly, the invention does not rule out a further web or two further webs being passed between the second surface of the first web-type material and/or the second surface of the second web-type material and/or the second surface of the third web-type material and also the cylinder surface of one or the cylinder surfaces of both roll or rolls, such further webs possibly being reusable. These further webs serve to reduce damage to the first and/or second and/or third web-type materials.

The activated plasma (“afterglow”) separated from the discharge zone is preferably carried in the direction of the laminating gap by means of a gas flow, for example, and therefore the laminating nip opened by roll and underlayer is filled with the excited gas. Accordingly, atmospheric gas can be displaced and unwanted reactions of the activated surfaces, particularly with atmospheric oxygen, can be reduced. The laminating gap seals off the zone which is filled with excited gas, and so the lamination takes place in the afterglow atmosphere. Consequently there are significant boosts to peel adhesion which were not expected beforehand, and which are also not achievable by means of separate pretreatments.

The method is able to achieve a boost in the peel adhesion between the layers across a wide range of pressure-sensitive adhesives and carrier materials.

The method is robust and is not dependent on optimized treatment for each adhesive and/or on optimized treatment for each carrier material.

The effect of the method taught is synergistic, i.e., is more than the sum of the individual effects of the treatment of carrier material or adhesive.

By virtue of the invention, the following desirable properties can be united in an adhesive tape:
high peel strength
high initial adhesion
high shear resistance
high temperature resistance
suitability for carrier materials with low surface energy (LSE)

In one variant of the method, the second web-type material is generally a substrate in the form, for example, of the substrate to which the first web-type material is laminated.

The laminating gap is formed by a pressing element and the substrate, which builds up an opposing pressure. In the laminating gap, the first web-type material is laminated to the substrate.

The first surfaces of the first web-type material and the surface of the substrate are treated simultaneously and preferably over the whole area with a plasma, more preferably such that the plasma, beginning ahead of the laminating gap and on into the laminating gap, acts continuously on the two surfaces.

The cylindrical surface of the pressing element is equipped with a dielectric, or the substrate is made of a dielectric material or covered with a dielectric.

Neither the first surface/the first web-type material nor the substrate is guided through the discharge zone of the plasma generation device.

A plurality of figures show advantageous variants of the method of the invention, without wishing to evoke restriction of any kind at all.

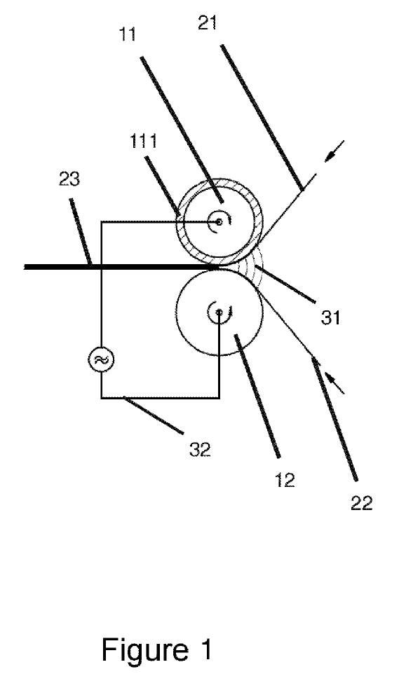

FIG. 1 shows a non-inventive method—the nozzle is absent. A laminating gap is shown, formed by a pressure roll 11 and by a counterpressure roll 12, which builds up the opposing pressure desired for lamination. The rolls 11 and 12, which are of equal size, run in opposite directions, but at identical peripheral speed. There is a layer of a dielectric 111 on the pressure roll 11.

On account of the voltage 32 between the rolls 11, 12, a plasma 31 is formed in the laminating gap. The laminating gap is fed with a first web-type material 21 and a second web-type material 22, continuously and with the same web direction. In this gap, the first web-type material 21 and the second web-type material 22 are laminated together, each by their first surface, to produce a laminate 23.

The first web-type material 21 is a layer of adhesive; the second web-type material 22 is a carrier.

Both first surfaces of the first web-type material 21 and of the second web-type material 22 are treated simultaneously with a plasma 31 in a plasma zone/with a plasma generating device, specifically such that the plasma 31 acts on the two first surfaces continuously, beginning ahead of the laminating gap and up to the laminating gap. Both first surfaces are not treated in accordance with the invention within the discharge zone, and are therefore located within the electrical field between the rolls, the strength of this field being sufficient to ignite a plasma under atmospheric pressure. This direct plasma influence can lead to damage to the webs, as a result of breakdowns within the electrical field, for example. Also possible is unwanted treatment of the second surfaces in the case of gas inclusions between webs and rolls.

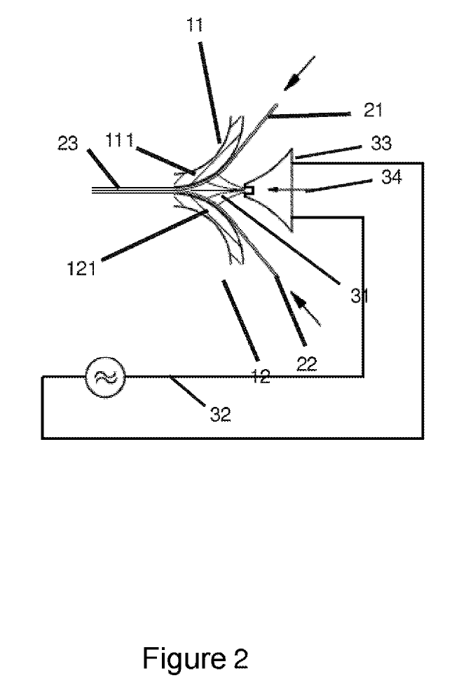

FIG. 2 represents a method according to the invention, showing only in each case one quarter of the rolls 11, 12. Both roll surfaces are equipped with respective dielectrics 111, 121.

The plasma 31 is generated by the plasma nozzle 33, provided in accordance with the invention, on account of the voltage 32 which ignites a plasma within the nozzle. The plasma is driven from the nozzle by a gas stream 34 and is transported into the nip region. Neither of the two first surfaces/web-type materials is guided through the discharge zone of the plasma generation device, which is situated within the nozzle or at the nozzle tip.

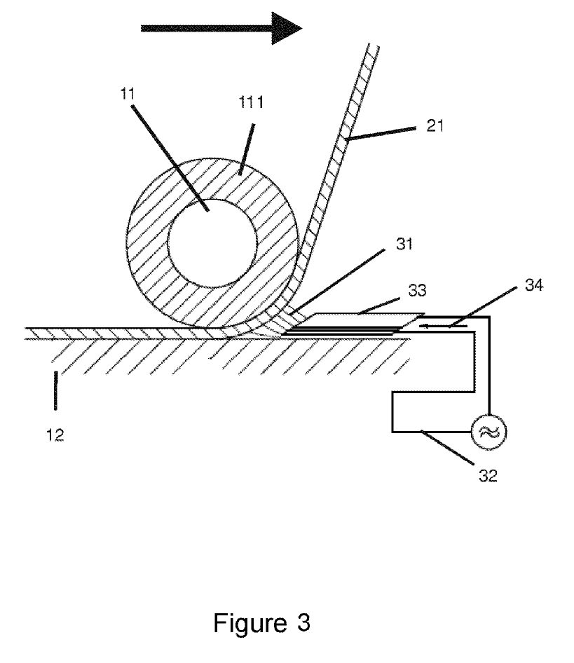

FIG. 3 shows a laminating gap which is formed by a pressing roll 11, which builds up the pressure desired for lamination, and by the substrate 12. A layer of a dielectric 111 is present on the pressure roll 11.

On account of the voltage 32 within the plasma nozzle 33, a plasma 31 is formed in the nozzle, and is driven from the nozzle by the gas stream 34 and transported into the nip region. None of the two first surfaces is guided through the discharge zone of the plasma generation device.

In the laminating gap a web-type material 21, consisting of a layer of adhesive, is laminated onto the substrate 12.

Both first surfaces (of the web-type material 21 and of the substrate 12) are treated over the full area with a plasma 31, specifically such that the plasma 31 acts continuously on the surfaces, beginning at the nozzle and up to the laminating gap.

The pressing roll 11 moves together with the plasma nozzle 33 at continuous speed in the direction dictated by the arrow along the substrate surface. Conversely, movement of the substrate is also possible.

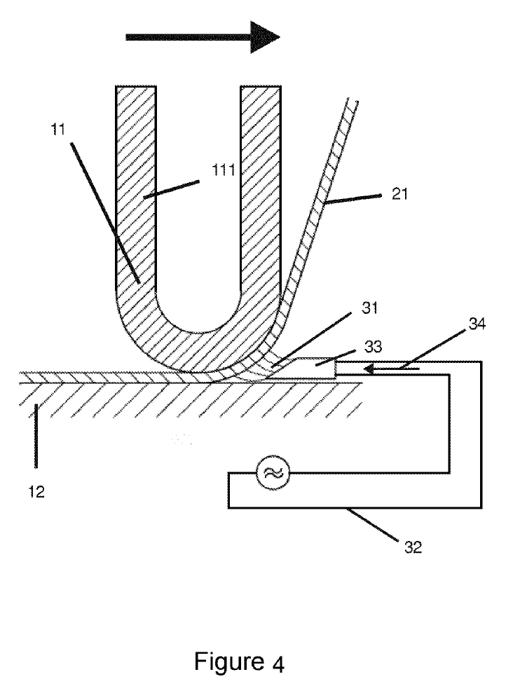

FIG. 4 differs from FIG. 3 in that instead of a pressing roll 11, a pressing element is used in the form of a pressing plate 11 with semicylindrical laminating surface.

1. A method for increasing the adhesion between the first surface of a first web-type material and a first surface of a second web-type material, said method comprising:
feeding the first web-type material and the second web-type material continuously and with identical web direction to a laminating gap, in which the first web-type material and the second web-type material are laminated together each by their first surface,
treating both first surfaces of the first web-type material and of the second web-type material simultaneously and optionaly over the full area with a single plasma, more optionally such that the plasma, beginning ahead of the laminating gap up to the laminating gap, acts continuously on the two first surfaces,
wherein the laminating gap is formed by a pressing element and a counter-pressure device which develops a counter-pressure,
optionally at least one of the cylindrical surfaces of the pressing element and of the counter-pressure device, or both, are furnished with a dielectric,
wherein
none of the two first surfaces/web-type materials is fed through the discharge zone of the plasma generating device.

2. The method as claimed in claim 1,
wherein
an arbitrary point on the plasma-treated surface of the first web-type material and/or the second web-type material travels the path from the start of the plasma treatment up to the laminating gap in a timespan of less than 2.0 s.

3. The method as claimed in claim 1,
wherein
a third web-type material is fed to the laminating gap in a way such that the second web-type material lies between the first and third web-type materials.

4. The method as claimed in claim 1,
wherein
the laminating gap is fed not only with the first and second web-type materials but also with a multiplicity of further web-type materials, with feeding taking place in such a way that the individual web-type materials enter the laminating gap between the first and second web-type materials, and the individual further web-type materials are selected such that in the laminating gap a non-adhesive carrier layer and a second non-adhesive carrier layer are never laminated directly to one another.

5. The method as claimed in claim 1,
wherein
the pressing element or the counter-pressure device are configured as a roll;
ptionally, pressing element and counter-pressure device are configured simultaneously as a roll.

6. The method as claimed in claim 1,
wherein
the pressing element is configured as a doctor blade or pressing plate.

7. The method as claimed in claim 1,
wherein
the counter-pressure device is the substrate.

8. The method as claimed in claim 5,
wherein
the rolls have a diameter between 50 to 500 mm.

9. The method as claimed in claim 1
wherein
the dielectric is a layer of plastic, rubber or silicone.

10. The method as claimed in claim 1,
wherein
the thickness of the layer of the dielectric on the roll or rolls is between 1 to 5 mm.

11. The method as claimed in claim 1
wherein the plasma is generated between one or more nozzles and the rolls, optionally on operation with compressed air or N2.

12. The method as claimed in claim 1,
wherein
the plasma is generated by means of a linear electrode with gas exit opening,
optionally one which extends along the entire length of the laminating gap and which further optionally has a constant distance from the laminating gap over the entire length of the laminating gap.

13. The method as claimed in claim 1
wherein
the distance of the plasma generating device from the laminating gap is 1 to 100 mm.

14. The method as claimed in claim 1,
wherein
the plasma generator can be displaced in its height perpendicularly to the plane which in turn lies perpendicular to the plane defined by the roll axes,
optionally simultaneously in its height and in its distance from the laminating gap.

15. The method as claimed in claim 1
wherein
the speed with which the webs are fed into the laminating gap is between 0.5 to 200 m/min.

16. The method as claimed in claim 1,
wherein
the second web-type material is a carrier material.

17. The method as claimed in claim 1,
wherein
the third web-type material has a layer of adhesive which is arranged in the third web-type material in such a way that it forms outer surface of the third web-type material and is laminated together with the second web-type material.

18. The method as claimed in claim 1,
wherein
the first web-type material is a layer of pressure-sensitive adhesive based on natural rubber, synthetic rubber or polyurethanes, the layer of pressure-sensitive adhesive consisting optionally of pure acrylate or predominantly of acrylate (with a thermal crosslinker system and/or hot melt and/or UV-crosslinked and/or UV-polymerized).

19. The method as claimed in claim 1
wherein
the layer of pressure-sensitive adhesive forms a carrier-free, single-layer, double-sided adhesive tape.

20. The method as claimed in claim 1,
wherein
the layer of pressure-sensitive adhesive is applied on a carrier.

21. The method as claimed in claim 1,
wherein
the thickness of the layer of pressure-sensitive adhesive or of the adhesive tape formed therewith is ≧20 μm, and/or not more than ≦2500 μm.
